(19) United States
(12) Patent Application Publication
(10) Pub. No.: US 2015/0227878 A1
(43) Pub. Date: Aug. 13, 2015

(54) Interactive Marketing Simulation System and Method

(71) Applicant: Acxiom Corporation, Little Rock, AR (US)

(72) Inventors: William Clay, Conway, AR (US); Brently Barrow, Little Rock, AR (US); Eric Joshua Stuart, Conway, AR (US); Martin Richard Rose, Superior, CO (US); Terry Talley, Conway, AR (US)

(21) Appl. No.: 14/617,584

(22) Filed: Feb. 9, 2015

Related U.S. Application Data
(60) Provisional application No. 61/937,162, filed on Feb. 7, 2014.

(51) Int. Cl. G06Q 10/06; G06N 5/04; G06Q 30/02; G06F 17/50

(52) U.S. Cl. CPC G06Q 10/06393; G06F 17/5009; G06N 5/04; G06Q 30/0241

(57) ABSTRACT

An interactive web-based marketing simulation game relying on a proprietary body of knowledge (BoK), techniques and methods allows marketing business leaders to simulate the likely outcomes arising from strategic choices made by the user or by management. A tool enabling modification to create evidence-based, objectively validated modified user data to increase the confidence in the predictability of the outcomes arising from strategic choices enables anonymous conversations between users through comments, questions and feedback. The result is a management planning and decision support tool capable of suggesting to the user that the user activate certain specific initiatives in a specific order to achieve desired outcomes within a desired timeframe.

### CROSS-REFERENCE TO RELATED APPLICATIONS

This application claims the benefit of U.S. provisional patent application No. 61/937,162, filed Feb. 7, 2014, for “Interactive Marketing Game.” Such application is incorporated herein by reference in its entirety.

### BACKGROUND

Following a number of disruptive changes that have arisen since the commercialization of the Internet, and following the rapid proliferation of smart phones, tablets, social media, and other new channels for marketing to consumers, companies need new and different tools, methods and data to make strategic decisions about how to deploy financial and human resources in a way that achieves optimal marketing results. Marketing scenario planning based on using mass media to promote brands, referred to as above-the-line (ATL) techniques, including TV and radio advertising, print and outdoor media, and web, Internet and mobile banner ads, but which does not consider below-the-line (BTL) techniques, such as direct mail and email marketing campaigns, trade shows and catalogs, and other forms of personalized marketing, and do not consider the underlying operational capabilities necessary to optimize marketing, invariably are less efficient in their use of time, human resources, purchased and manufactured data, and computational resources. Put simply, the old tools, methods and data (from 10 years ago, for example) do not “scale upward” to address the new business problems faced by marketers today. Attempting to use old tools, methods and data to make these strategic decisions increases errors, computer processing time and resource consumption, leading to delays in implementation of improvement initiates, missed opportunities, and poorly optimized computing infrastructure.

Prior generation planning scenario simulation tools and methods do not address the business problems raised by the Internet, connected devices such as smart phones and tablets, and other marketing tools, channels and resources. In addition, the quantity, quality and underlying structure of the data elements needed to make, implement and evaluate the success of optimization initiatives have reached a level of complexity that requires a break from traditional planning scenario and simulation methods, and the adoption of new tools and methods that break from the past.

In Business-to-Consumer (B2C) marketing, the ability to make strategic marketing decisions that lead to improved new customer acquisition, cross-sales and up-sales results, customer retention, revenue growth, customer satisfaction and profit improvement are essential to the success of the company. Yet marketers do not possess the knowledge, skills, data and tools to optimize marketing capabilities in a way that leads to measurable improvements in performance.

Old decision making methods based on direct marketing scenario simulation do not consider the impact of smart phones, the Internet and social media. These methods do not scale in a linear fashion to address multi-product, multi-channel, multi-device, multi-platform direct marketing. There is not a logical progression from single channel scenario simulation to multi-channel scenario simulation. In addition, new tools and methods are needed that incorporate data and decision making approaches that simply did not exist prior to the commercialization of the internet, and prior to the rapid proliferation of smart phones, tablets, and social media. For example, the allocation of budget to marketing expenditures by marketing channel and device platform will result in different marketing results. Any scenario planning approach that does not consider the implications of budget allocation across channels cannot achieve optimal outcomes. Modeling the variables in a singular, sequential fashion produces results that are not optimized, and requires excessive computer processing and resource consumption. Nor does it simultaneously take into consideration the correlative relationships that exist among a larger set of variables. Companies do not have access to the normalized benchmark data that are needed to perform optimization, and to attempt to construct benchmarking exercises independently to fuel decision making requires excessive computer processing and resource consumption.

The lack of a logical progression in marketing outcomes that rises from migrating from single channel scenario simulation to multi-channel scenario simulation is a root cause of computational inefficiency. This inefficiency is created in general computing equipment when methods of data collection are introduced which do not address the conflation that exists between marketing channels. When two or more marketing channels, marketing campaigns, or marketing content (i.e. advertising, messaging, or promotional offer) occurs in different places or in the same place across multiple time intervals, each sharing some characteristics of the another, the outcomes appear to arise from a single marketing capability, and the differences in capability improvement that are needed to improve outcomes with a reliable and measurable degree of predictability appear to become lost. The desired system must anticipate and prevent conflation through a new experimental design that joins, or assembles, qualitative and quantitative data such that scenario simulation is possible using less powerful computational equipment and limited computational cycles.

Further, the ability to market to consumers effectively across devices, channels, platforms and social media sites requires specific marketing capabilities, including capabilities for closed-loop evaluation of the outcomes achieved through investing in the new capabilities. Without the ability to identify the current level of capability maturity for these capabilities, and to model the effectiveness of making improvements to one (or more) capability attributes that must be improved, and in which priority order to improve each particular capability attribute maturity, business executives are unable to conceive of, execute and measure the effectiveness of execution for strategic initiatives that have a demonstrated correlation to improved marketing performance as measured and reported through marketing key performance indicators (KPIs).

What is desired then is a system for collecting, assembling, modifying and evaluating content and data for performing marketing scenario simulation, predicting specific, measurable outcomes that are empirically reproducible, and making, testing, and optimizing specific business decisions surrounding capability improvement programs for marketing to consumers. The desired system should reduce the computational errors that are typically introduced by performing scenario simulation on variables that are not tightly defined and whose scoring is not based on rigidly defined design of experiments (DOE) or experimental design. The method and underlying design of the information-gathering exercises must not introduce variation into the computing process. Where high variation is present, the error rate increases, statistical confidence is reduced, and additional computational cycles are required for the applicable computing resources, or the introduction of more specialized computing equipment is required to achieve the computational objective. A system design that requires additional computing cycles and/or such specialized computing equipment reduces computational efficiency, and limits the adoption of advanced scenario simulation in the post-internet age to only a “privileged few.”

It is not enough that the system generate measurable outcomes that are empirically reproducible, resulting in making, testing, and optimizing specific business decisions surrounding capability improvement programs for marketing to consumers. In addition, the requirements for total cost of ownership (TCO) for such a system must be such that the system can be operated within the technology architecture that is common among companies, and must be capable of operating at high levels of efficiency, low computational cycles, low requirements for redundancy, and at a low error rate.

Progress toward optimizing the actions needed to increase marketing capability is measured by a marketing maturity quotient (MMQ) developed by Acxiom Corporation, and by improvements in specific KPI measurements over time. The MMQ is a comparative index, based on a maximum possible score of 100, for aggregated level of capability maturity across Capabilities, Dimensions, and Attributes, as defined by the Maturity Model Body of Knowledge (BoK) for marketing capabilities.

### BRIEF SUMMARY

The invention is directed to a system and method by which specific content is collected, assembled, modified and evaluated through an interactive game interface, which in certain embodiments is a collection of web forms facilitating users to enter content and data as prompted, and allowing modification and evaluation by authorized users. The web forms are administered in certain implementations through a custom portal made available on an access-restricted basis to specific users, as recorded in an administrator function within the commercially available Salesforce.com (SFDC) sales automation software platform. Access restrictions prevent any user from viewing, modifying, extracting, or otherwise having any access to direct content and data supplied by another user, unless they have the specific permissions required to do so.

The web forms themselves in various implementations have been designed in various implementations in a way that exposes proprietary content from a Marketing Maturity Model Body of Knowledge (BOK), including Capability definitions, Dimension definitions, Attribute definitions, and definitions for Level of Maturity, specific Key Performance Indicators (KPIs), and the definitions for each KPI. This unique experimental design and methodological approach allows for the collection of data according to an extremely objective and rigorous protocol, especially for qualitative information that is often considered to be ‘softer’, more subjective, and relegated to a position of lesser importance than quantitative data. It is in fact the exacting standards developed to procure and assemble this data that reduces errors and permits it to be incorporated in a normalized database, and thereby facilitates objective comparisons across a wide range of corporate entities, anticipating and preventing conflation through a new experimental design that joins, or assembles, qualitative and quantitative data such that scenario simulation is possible using more widely available computing equipment and limited computational cycles. Assembling the data in this fashion and using it in a software tool predicated on game theory makes the knowledge and experience of many corporations accessible to an individual company. This synergistic effect will become stronger as more corporate users contribute to the body of knowledge. The correlation or joining of quantitative data to qualitative data in a normalized database prior to analysis serves to increase the efficiency of the computing system performing the analysis operations, since fewer clock cycles are required in order to perform an analogous analysis as would be required without this correlation/integration.

The specific content and data collected, assembled, modified and evaluated includes, in certain implementations:

(1) User Supplied Content (USC), or qualitative content, covering the entire domain of multi-product, multi-channel direct marketing, as defined in the Marketing Maturity Model Body of Knowledge (BOK), including Capability definitions, Dimension definitions, Attribute definitions, and definitions for each Level of Maturity, designed such that different marketing capabilities which share some characteristics of one another, and which seem to have a single identity, can be anticipated and removed as a possible future source of computational inefficiency and error;

(2) User Supplied Data (USD), or quantitative outcome-oriented content, also covering the entire domain of multi-product, multi-channel direct marketing and expressed in the form of KPIs, and more particularly, by assigning one or more marketing performance metrics to a grouping of marketing capability attributes, and to a company, or a division of a company that has entered USC or is otherwise associated with USC that has been generated at a specific point in time, covering a specific time period. Point-in-time performance measurements for KPIs used by a company, or a division of a company, indicate that entity's marketing performance, i.e.: the ability of that company to convert human and financial resources, products, brand, goodwill, and other assets into revenue and profit arising from increased customer acquisition, increased customer retention, increased Net Promoter Score (NPS) and increased customer lifetime value (CLTV) or net present value (NPV) at a specific point in time, covering a specific time period;

(3) Modified User Supplied Content (MUSC), is created through the subsequent modification of USC, through the addition of independent External Evidence. MUSC further identifies and emphasizes the contrasts between different marketing capabilities which share some characteristics of one another, and which seem to have a single identity. This conflation in capabilities can be anticipated and removed as a possible future source of computational inefficiency and error by the addition of objective and independent evidence. Since the fusion of distinct subjects tends to obscure analysis of relationships which are otherwise obvious through advanced analytics, failure to identify the contrast between different marketing capabilities produces errors or misunderstandings in predictive relationships.

(4) External Evidence is gathered by the game administrator, and/or by a third-party services provider, such as a professional consultant, business analyst, or market research analyst, whether acting in a paid or un-paid capacity. External evidence can include third-party data and evaluation, and externally observable evidence, such as publically available reports, purchased data, and benchmark data. USC may be modified by the experience of a third-party services provider, such as a professional consultant, business analyst, or market research analyst, whether acting in a paid or un-paid capacity. In alternative implementations, modification of USC to produce MUSC can be automated, or the external evidence used to produce the MUSC can be directly incorporated into the database, such that it is not used or not used only to directly modify the USC, but represents a separate data set.

The collection and assembly of USC and USD, with modification via independent third-party data and evaluation, and externally observable evidence as described is a method for performing scenario simulation leading to hypothesis testing, decision making, measurement of effectiveness of decision implementation, and decision optimization.

The game is based on a (BoK) for marketing capabilities and marketing KPIs, and is accessed through interactive web forms, where players interact with a graphical user interface to enter certain inputs which collectively form individual scenarios or game sessions. Then, based on the methodology, simulations—with a known level of confidence—illustrate the likelihood of achieving certain desired business outcomes or results, following activation of the initiatives that are selected by management as suggested by the game. Once the user acts on the initiatives and measures the outcomes, the outcomes are entered into the game through the same user interface, they become part of the normalized database, and new suggestions are developed, leading to increasing levels of optimization, and improved outcomes over time. The use of the normalized database greatly reduces the computational complexity required for each iteration of the game, thereby improving the performance of the computing system used to implement the system remotely from each of the client organizations that are using that system.

Simulating, predicting, deciding, and measuring the performance improvements that result from the execution of optimized strategies and tactics is essential to the successful management of marketing. To be successful in marketing in the current business climate, marketers need to simulate and test specific predictions—based on a solid empirical foundation—about how customers will respond to specific marketing actions and investments across products, channels, and over time. Outcomes need to be simulated before committing financial and human resources to the creation of new capabilities through new strategic initiatives. The simulation should be done based on an empirical foundation derived from the accumulated results of similar investments made by others, and with a high degree of scientific, repeatable analytical discipline, rather than through guesswork.

In various implementations the invention collects and assembles content and data integrated in a simulation tool that provides marketers a reasoned attempt to predict the behavior of consumers, resulting in measurable business performance improvements (outcomes). It applies in business situations where future results need to be modeled for planning and budgeting purposes, where simulations need to be performed using a system that can be operated within the technology architecture that is common among companies, and must be capable of operating at high levels of efficiency, low computational cycles, low requirements for redundancy, and at a low error rate.

In organizations, (and this is especially true for marketing) business results depend on the responses of others (such as customers, prospects, consumers, etc.) to the choices (also called “scenarios”) made by management. The scenarios represent business investments in individual capabilities, which share some characteristics of one another, and which may seem to have a single identity. Since the fusion of distinct subjects tends to obscure analysis of relationships which are otherwise obvious through advanced analytics, creating contrast between different marketing capabilities during scenario planning reduces computational errors and increases the accuracy and usefulness of the prediction.

Interactive gaming models in various implementations include: (1) a single player; (2) a set of actions that the player can choose (also known as “scenarios”); and (3) the “payoffs” (how much the player will win or lose as a result of each scenario in terms of marketing performance). More complex gaming models allow for: (1) assembly of outcomes from many single-player sessions, using the results of single player sessions to develop benchmarks which apply to all players who are clustered into a single division within a single organization; (2) across multiple divisions of a single organization; (3) across multiple organizations making up an industry group, or (4) across multiple organizations and/or industries in a geography segment; (5) a broader range of scenarios; (6) statistical correlation of expected outcomes (“payoffs”) to user-defined inputs, and (7) the ability to perform closed-loop measurement of activated initiatives across multiple sessions, each corresponding to a specific point in time. As the simulations become more complex and more iterations are run, the computer system efficiencies introduced by the use of the normalized database for collecting and maintaining integrated qualitative and quantitative data become more pronounced.

### BRIEF DESCRIPTION OF THE DRAWINGS

FIG. 1 is a block diagram showing an implementation of the invention to collect, evaluate, modify, and analyze USC, USD, MUSC, and external evidence.

FIG. 2 is a block diagram depicting content collection and distribution in an implementation of the invention.

FIG. 3A is a block diagram depicting a data correlation system according to an implementation of the invention.

FIG. 3B is a selection of displays showing data correlation according to an implementation of the invention.

FIG. 4 is a data diagram showing data correlation according to an implementation of the invention.

FIG. 5 is a block diagram showing a business intelligence topology according to an implementation of the invention.

FIG. 5B is an example of a requirements table with each row of the table representing the correlation of an attribute to its KPI and USD according to an implementation of the invention.

FIG. 5C is an example of a simulation report that displays the highest likelihood simulations of achieving the desired business outcomes key performance indicator (KPI) goals in a certain implementation of the invention.

FIG. 6 is a block diagram showing a process for developing a marketing improvement plan (MIP) according to an implementation of the invention.

FIG. 7 is a KPI pyramid structure according to an implementation of the invention.

FIG. 8 is a diagram showing a prioritization of country sequencing according to an embodiment of the invention.

### DETAILED DESCRIPTION

In certain implementations, the invention is directed to a specific technique for determining, testing, and optimizing the actions needed to increase marketing capability as measured by the marketing maturity quotient (MMQ) and related marketing performance across time as measured by specific key marketing performance indicators (KPIs), which may also be referred to as marketing metrics, for a particular organization or division within an organization are described. User supplied content (USC) is entered by a user. A user is a particular individual acting on behalf of an organization or division within an organization.

The data correlation module of the game has two major components that ultimately produce information that populates other tables: the Body of Knowledge (BoK) represented by the records in the anonymized normalized database, and then all of the information supplied by a new user or authorized third party acting on behalf of a company or company division. Combining (also referred to assembling) these two components is what allows the game to assimilate information from a new user and generate predictions regarding various outcomes and payoffs, as modeled by the user in user defined scenarios, while also providing superior performance in the computing system implementing the invention due to the normalized database. These predictions are incorporated in the production of the Marketing Improvement Plan (MIP).

The normalized database is the repository of information accumulated from many organizations and organization divisions from specified points in time. It contains records of user-supplied information, and subsequent modifications, for all of these entities. These are the values for the attributes associated with particular capabilities and dimensions. As an example, one of the dimensions of the information management capability is collecting on and offline data. One attribute of this dimension pertains to offline data collection and assembly, and like other attributes it is rated on a scale of 1 to 5, where level 1 is the lowest performance and 5 is the highest. This information is available for 81 different attributes in a particular implementation.

The division of marketing capabilities into cascading levels of detail—referred to as dimensions and attributes—reduces the computational errors that are typically introduced when simulation variables are not tightly defined, and whose capability maturity scoring is not based or rigidly defined experimental design. The method and underlying design of the information-gathering exercises must not introduce variability into the computing process. The error rate increases in experiments when high variability is present, statistical confidence is reduced, and additional computational cycles are required for general computing equipment, or specialized computing equipment must be introduced to achieve the computational objective.

The normative database also contains other significant information—including values for other variables representing outcomes and payoffs resulting from the closed loop reporting structure inherent in the game. This database provides the benchmark ability to empirically associate particular inputs with particular outputs, based on similar observations collected with the same protocol across many companies.

Stated another way, the database allows for the creation of predictive (correlative) relationships between an independent variable, or set of variables, and a dependent variable, based on a large number of benchmark observations. These relationships may be of a simple bivariate nature where variable Y is expressed as a function of variable A, or a more complex multivariate situation where variable Y is expressed as a function of variables A, B, C, etc. As noted elsewhere in the text, these functional relationships are not necessarily constrained to a simple linear nature; they may represent significant complex positive and negative non-linear relations between and among variables. Because these predictive relationships are based on many observations, it allows the amount of error (variability) associated with a particular prediction to be specified. Some predictive relationships are weaker than others and are associated with larger error, while others are very strong and have a smaller error component.

Predictive relationships, whether bivariate or multivariate, are predicated on a univariate understanding of the statistical characteristics of individual variables (e.g. attributes). Univariate statistical characterization defines the central tendency and variance of a variable with commonly accepted metrics like mean, median, standard deviation, skewness and so on. It also enables a particular value for one corporate entity to be compared against all of the other companies in the database. A simple example would be how a user entered attribute value compared to the mean and standard deviation value of the same attribute for all or a subset of observations in the database.

The second component of the correlation block is user supplied data. The information supplied by a user for an organization or organization division contains values for the variables in the normalized database, the same type of information previously entered for other organizations. What is initially unknown are the values of payoffs and other outcomes that result from closed-loop reporting of actions that will be taken by the organization in response to specific recommendations created from the game and the management improvement plan (MIP).

On the simplest level, as previously mentioned, it is possible to establish numerically and graphically how the user's organization or organization division benchmarks against other organizations represented in the database on a variable-by-variable basis. But the real power of the game is derived from the predictive relationships inherent amongst the variables in the database, which also contains real measured values of outcomes and payoffs obtained by following the recommended MIP. The game allows predicted values for those payoffs and outcomes, based on the whole body of information present in the normalized database. As previously mentioned these predictions are made with an associated level of confidence. The predictions are used to populate tables used by other game components.

After a new user/organization executes on the MIP, the impact of the actions taken can be expressed in terms of payoffs and other outcomes. These real measures can be recursively added to the particular company's record that becomes part of the normative database as well. Additional information regarding the difference between actual and predicted performance aids in making further predictions calculated from the normative database (NDB) more statistically representative.

Each of the marketing capability attributes defined in the Body of Knowledge (BoK) receives a numeric score of 1-5. The score represents the qualitative content of the user regarding the level of maturity for each attribute at the current time. Levels 1 through 5 which comprise an ordinal scale, or ranking, each have specific definitions for the user to reference as they perform their scoring. Level 1 represents a lower level of performance or sophistication than 5. The user's USC for each of the attributes may be entered for multiple time periods, to create a time series.

USC may be subsequently modified through the addition of independent third-party data and externally observable evidence, such as publically available reports, purchased data, and benchmark data. USC may also be modified by the experience of a third-party services provider, such as a professional consultant, business analyst, or market research analyst, whether acting in a paid or un-paid capacity. When USC is modified by external evidence, it becomes modified user supplied content (MUSC).

The KPIs from the Body of Knowledge (BOK) are selected by the user and the actual measured results for each of the selected KPIs are entered representing a particular point in time. The user's USD measured results for each selected KPI may be entered for multiple time periods, to create a time series. In addition, the user's goal, or target values are entered, for each KPI selected. For each KPI goal or target, a time frame is specified indicating the user's desired time frame for achieving the goal value. For example: 1 year, 2 years, or 3 years. USD may be supplemented through the addition of independent third-party data and externally observable evidence, such as publically available reports, purchased data, and benchmark data.

Based on proprietary techniques, specific actions are suggested in a specific order, which taken together, are indicative of the optimal set of actions needed to be taken by the user at a particular point in time to achieve the users KPI goals. Once the user makes specific elections from the suggestions, a Marketing Improvement Plan (MIP) is published by the game and directed from the remote computing system to the client device for display. The MIP details the specific capability maturity improvements that must be implemented by the user to achieve the users KPI goals.

The user may revisit the MIP in multiple, subsequent game sessions, to update the USC and USD with current-period USC and USD. Following each game session, the MIP may be refreshed with new action optimization suggestions. With each new user session, the underlying statistical relationships become more representative through recursion.

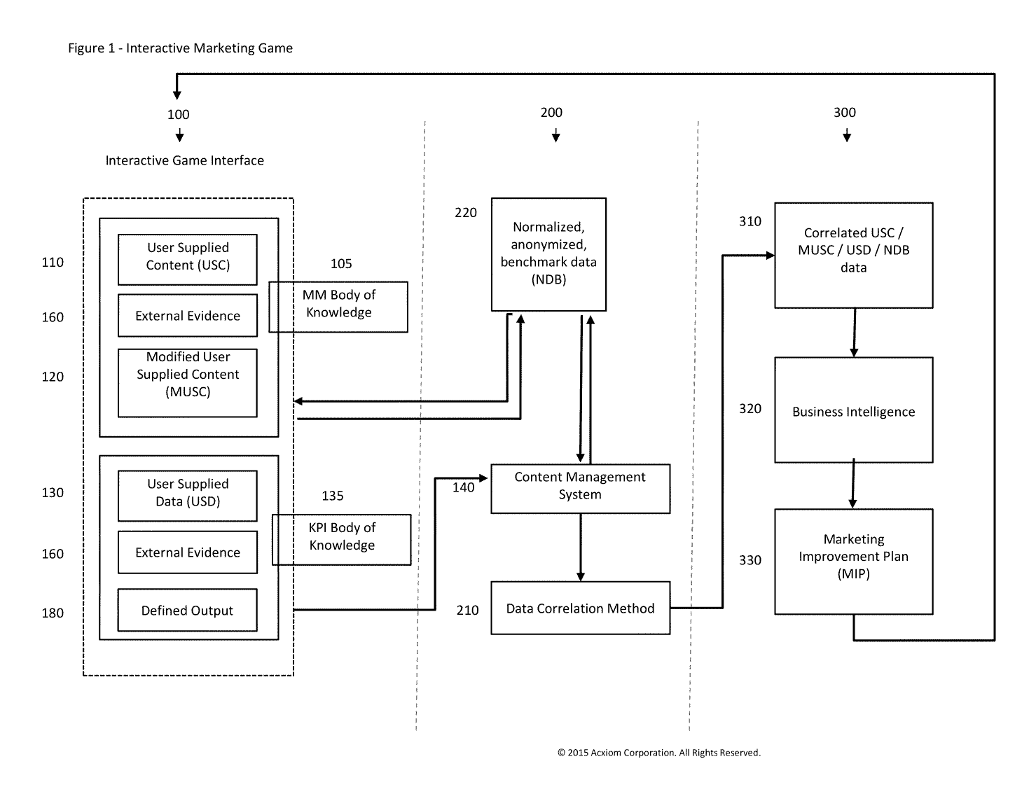

Turning now to FIG. 1, a block diagram is shown of one embodiment of a system that is configured to collect, evaluate, modify and/or analyze USC, USD, MUSC, and external evidence. The method of collection of user-supplied content, user-supplied data, modified user supplied content, and external evidence are all shown within one high-level illustration. However, in other embodiments, all or a portion of any of the components shown as being included within interactive game interface 100 may be logically placed elsewhere, including being integrated with an existing system of record holding the user supplied content, user supplied data, and/or external evidence. In various embodiments, all or a portion of any one of the components depicted in FIG. 1 may be combined with one or more of the systems and/or components shown in FIG. 1.

“User supplied content” (USC) 110 refers to specific qualitative content entered by a user. A user is a particular individual acting on behalf of an organization or division within an organization. Each of the marketing capability attribute scores are associated with the particular individual's opinion of the capability maturity for a respective particular one of the attributes, at a particular point in time, using pre-defined standard definitions for capability maturity. The user supplied content is a numeric score from 1-5 representing their qualitative content of the capability maturity for a respective particular one of the attributes.

USC 110 may be received from a large variety of users or sources, including websites of providers, content received from consultants, external analysts or agents, and other purchased sources. Following normalization and anonymization, USC 110 may be displayed to other users as benchmarks stored in NBD 220, thereby affecting their opinions which they enter as USC 110.

The commercialization of the Internet has made qualitative data less meaningful and quantitative data more meaningful in business management. As a result, capability maturity models that derive their assessment purely from qualitative data are no longer as desirable as models based on quantitative data.

Techniques and structures described herein allow authors of particular USC 110 items to be identified as being influential and as being “in-market” for business improvement services. These authors may be identified in various fashions, and may have associated contact information such as an email address, phone number, user identification, etc. USC 110 authors may be analyzed for need and fit of business improvement services, considering particular industries and geographies, brands, types of goods or services, categories, and other factors.

Once identified, various actions may be taken with regard to such authors. Demographic data may be used for example, if authors of USC 110 are in-market for services, and are identified as being in leadership positions within their organizations, a service provider may wish to contact them to offer services.

Note that herein, marketing capability maturity and/or marketing performance may be measured, calculated, analyzed, determined, etc., with respect (and without limitation) to any of: an industry, or geography, a product, a service, a brand, a type of product, a group of products (which may or may not be of the same type), a group of brands and/or services, a supplier, a manufacturer, a retailer, (e.g., any provider), and other objects, services, individuals, and entities, revenue, headcount, gross media spend, etc.

Interactive game interface 100 is logically divided into data content collection, marketing capability content, modified user supplied content, Key Performance Indicator content collection, collection of External Evidence, and defined output. In USC 110, using the interface supplied by interactive game interface 100, user supplied content (USC) 110 is entered by a user. Each of the marketing capability attribute scores is associated with the individual's opinion of the capability maturity for each attribute, at a particular point in time.

The opinion of the user is collected via a scoring system based on pre-defined standards for capability maturity. The user references the standard definition for each level of maturity supplied by BoK 105 and then enters his or her opinion of the current state of capability maturity for the each attribute. The user's USC 110 for each one of the marketing capability attributes may be entered for multiple time periods—for example, on a monthly, quarterly, or annual basis—to create a time series for USC 110.

In modified user supplied content (MUSC) 120, using the interface supplied by interactive game interface 100, USC 110 may be modified through the addition of independent third-party data and externally observable evidence (See external evidence 160 below), such as publically available reports, purchased data, and benchmark data. USC 110 may also be modified by the experience of a third-party services provider, such as a professional consultant, business analyst, or market research analyst, whether acting in a paid or un-paid capacity. When USC 110 is modified by external evidence, it becomes modified user supplied content (MUSC) 120.

Using the user interface supplied by interactive game interface, USD 130 is entered by a user. A user is a particular individual acting on behalf of an organization or division within an organization. Each of the key performance indicators are entered by the user, and are associated with the particular individual's measured results for a respective particular one of the KPIs, for a particular point in time. The user's measured results for each of the KPIs may be entered for multiple time periods—for example, on a monthly, quarterly, or annual basis—to create a time series for measured results.

In external evidence 160, the addition of independent third-party data and externally observable evidence, such as publically available reports, purchased data, and benchmark data has been applied to modify USC 110. USC 110 may also be modified by the experience of a third-party services provider/content reviewer, such as a professional consultant, business analyst, or market research analyst, whether acting in a paid or un-paid capacity. When USC 110 is modified by external evidence 160, it becomes modified user supplied content (MUSC) 120.

In defined output 180, using the interactive game interface 100 business rules and instructions are entered by a user to determine the KPI improvement that is desired and define the correlation method and output.

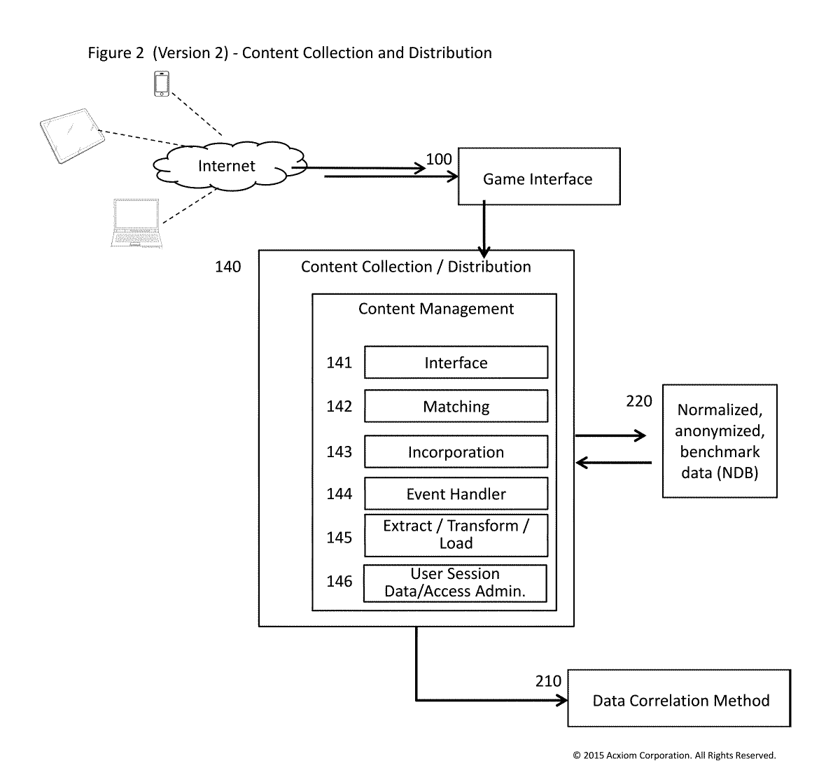

Turning now to FIG. 2—140 Content Management, a block diagram is shown in more detail by which content, data and third-party data and evidence are received from interactive game interface 100 and normalized benchmark database (NDB) 220 and distributed to other systems through data correlation method 210. In interface 141, a user interface is supplied to facilitate the entry of USC 110 by a user, the addition of independent third-party data and externally observable evidence by a user or by a system administrator, and the entry of user supplied data (USD) 130 by a user. The user interface also allows for anonymous conversations between users through comments, questions and feedback. In matching 142, a matching logic is illustrated. All USC, USD, and external evidence is matched to user id, session id, date/time, company id, division id, capability id, dimension id, and attribute id. In incorporation 143, software code is illustrated to incorporate the display of context-sensitive help screens that are presented to the user to increase the validity of USC 110, as well as to assist the user navigate the interactive features of the game.

The “validity” of an individual USC 110 element is defined by the intercoder reliability that is inherent to the methodology. For example, validity is measured by the degree of correlation to NPS (Net Promoter Score), and the percentage change that is seen in the individual USC 110 element following the introduction of external evidence. NPS is a known management tool that can be used to gauge the loyalty of a company's customer relationships. Other such tools are known and can be used in alternative implementations.

In event handler 144, an event handler coordinates and verifies user identity, user permissions, user input, user actions, and browser actions, including the actions that must be performed every time a page loads, actions that must be performed when the page is closed, and actions that must be performed when a user clicks a button.

In extract/transform/load module 145, a process of extracting external evidence data from pre-defined source systems and/or data tables and bringing it into the data storage utility, maintaining the data, and making it available to other system processes, is illustrated.

In user session data/access administration module 146, software code is illustrated to facilitate the access and permissions of authorized users for the game.

Accordingly, content collecting and distribution system 140 interfaces with normalized benchmark data 220 that includes all content and data generated from various sources. USC and USD may be stored with a variety of metadata including user identification(s) for users, or identification of a web site from which external evidence was sourced. Other information besides content of USC, USD and external evidence may be determined based on a user's actions (such as the number or revisions submitted by the user, or other factors, scores, and/or metrics as discussed herein).

Content collection and distribution system 140 may also maintain a set of user data, which may include information on individual users who have submitted USC 110 and USD 130. Such information may include session id information, user names, email addresses, and any other information for a user.

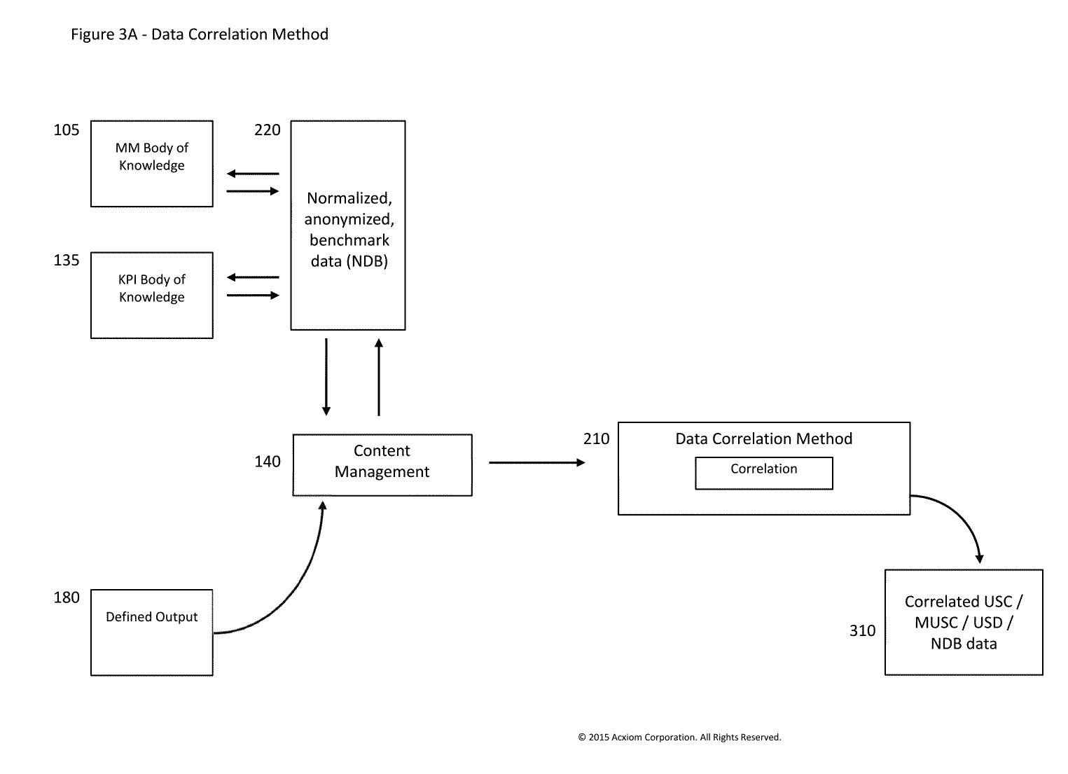

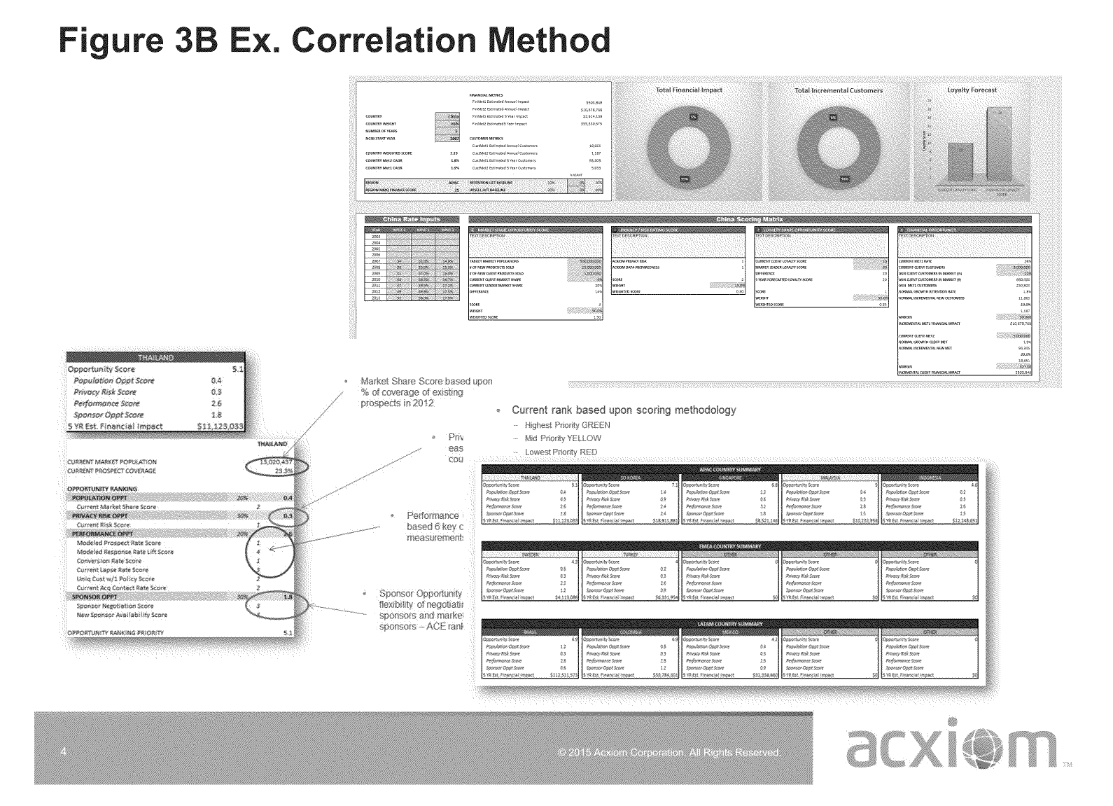

Turning now to FIG. 3A—Data Correlation Method, a diagram is shown by which user content, user data and user defined output are utilized to calculate output (tables, metrics and reports). From 180, business rules and instructions, which have been defined by user and are used by the correlation method and to determine which report(s) output or optimized scenarios, are received within content management system 140. From content management system 140, it takes the instructions and business rules and in turn informs NDB 220 of required data variables to be utilized within data correlation method 210. Variables from NDB 220 embody MMQ, KPIs, metrics, and other user defined/supplied information; however, are not limited to those variables.

Correlation method 210 combines USC 110, USD 130, external evidence 160, MUSC 150, and NBD 220 to calculate tables, metrics, and reports to produce output 310 comprising correlated USC/MUSC/USD/NDB data 310.

Turning now to FIG. 3B—Correlation Method Output, identifies examples, but not limited to the examples displayed, of potential outputs from the data correlation method, 210, as displayed to a user at a client device. The correlation output presents the findings and calculations of correlation method 210 in a manner that provides optimized predictive scenarios from the data.

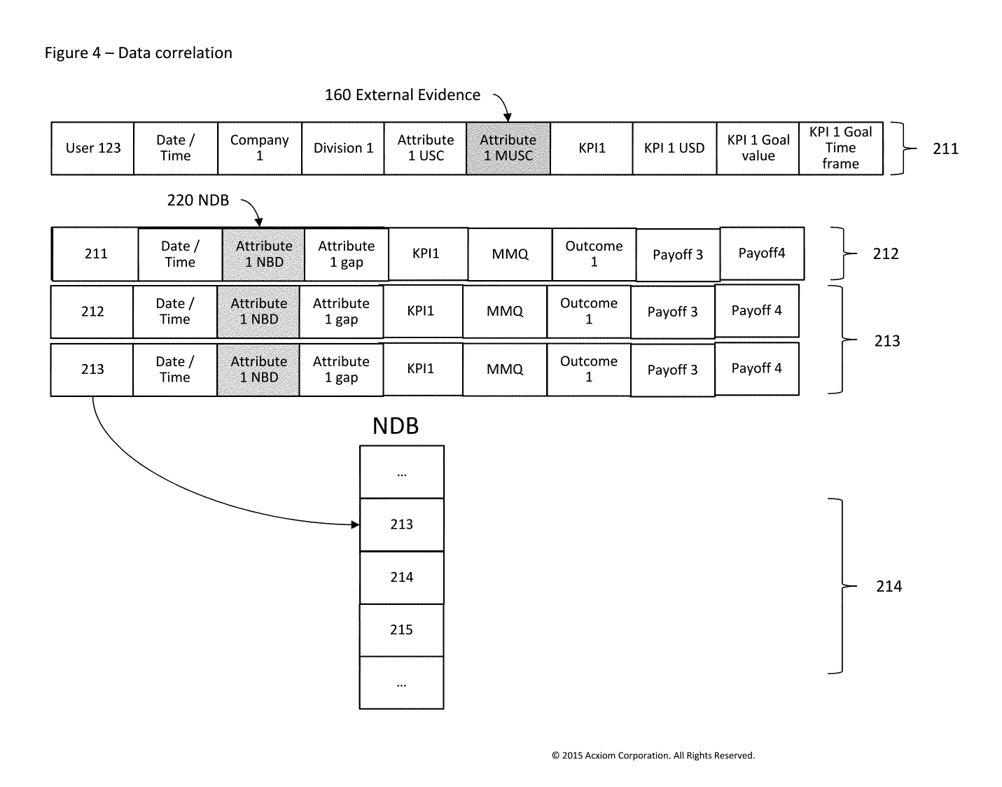

Turning now to FIG. 4—Data Correlation, a block diagram is shown by which content, data and third-party data and evidence are received from a user and distributed to other systems. From 211, information supplied by a user acting on behalf of an organization or organization division contains values for variables present in the normalized database. This portion of a record shows that on a particular date/time User 123 from Company 1, Division 1 entered a value for user supplied content attribute 1, KPI user supplied data, and the target goal for KPI 1, and the time frame in which it will be achieved. From 160 external evidence it shows that attribute 1 was modified based on external evidence.

From 212, the partial record for 211 from the normalized database, which is derived from 220 NDB, shows the value for attribute 1 and the attribute 1 gap, which is the difference between the actual value and the target. It also holds values for variables KPI 1, MMQ, outcome 1, and payoffs 3 and 4.

From 213, the partial records represented for 212 and 213 show the same information as contained in record 211, though populated with specific values for those particular corporate entities. These are vastly simplified representations of all the records in the NDB in certain implementations. What is important to note is that the records in the NDB contain all of the same information contributed by User 123 shown in 211, but in addition they contain values for various outcomes and payoffs resulting from taking actions presented in the Marketing Improvement Plan (MIP). These latter values are not present with the initial harvesting of information from User 123. From 214, records 213 to 214 are shown as elements within NDB 220.

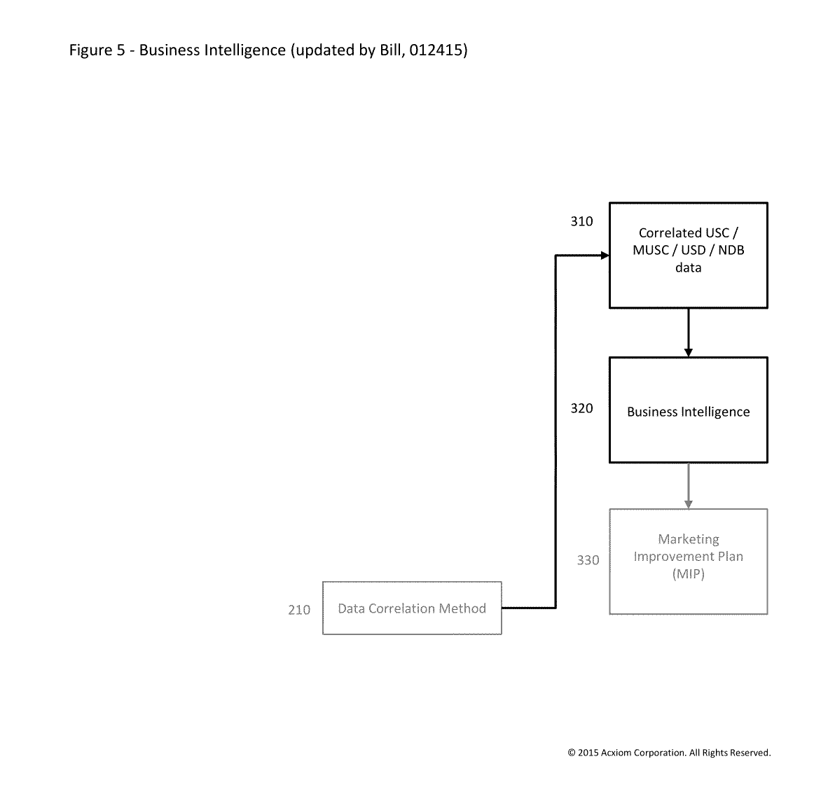

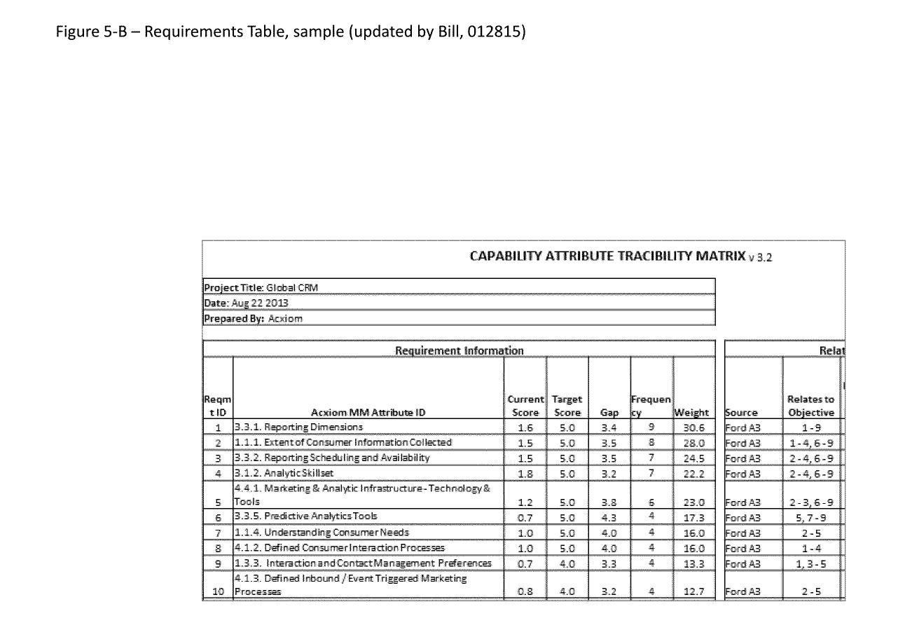

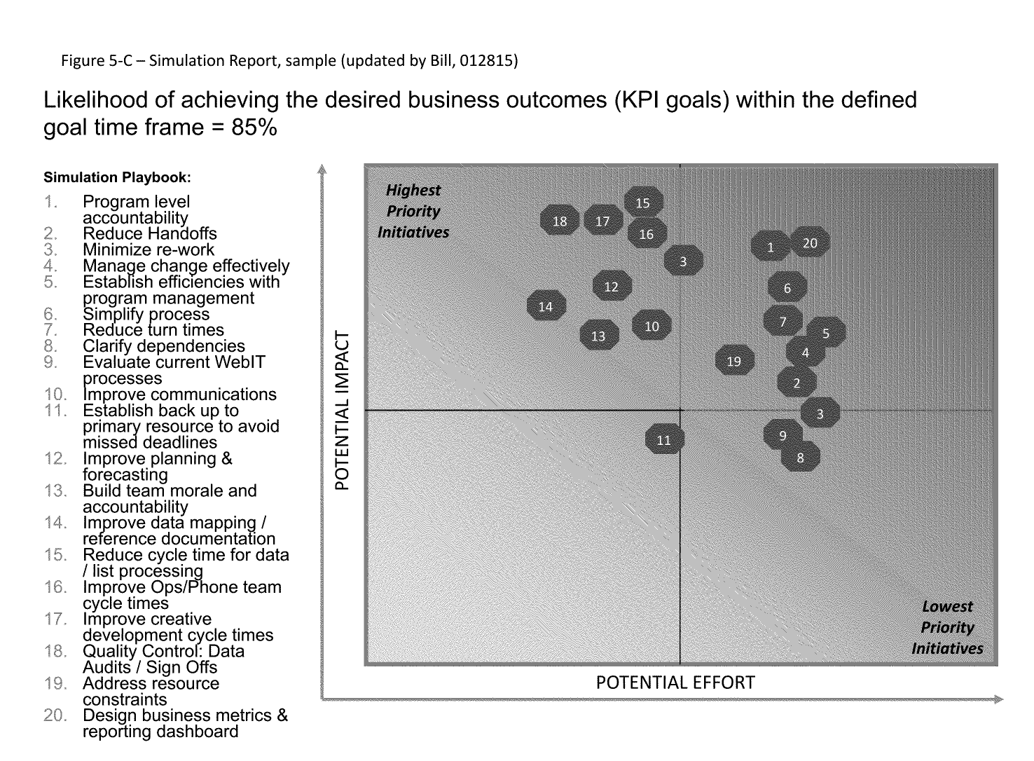

Turning now to FIG. 5—Business Intelligence, a block diagram is shown by which correlated content and data are received from data correlation method 210 and augmented with business intelligence 320 to then be supplied to marketing improvement plan (MIP) 330 for the creation and publication of an improvement plan to a user through a client device from a remote marketing capabilities computer system. The correlation of USC 110 and USD 130 as described is a rigorous and objective, unique and non-obvious method for establishing the priorities needed for specific business improvements, for the user to achieve the desired outcomes identified as KPI goals. In 310—Correlated USC/MUSC/USD/NDB data are assembled in an automated fashion in a requirements table (FIG. 5-B—Requirements Table, sample), which may also be known as a Capability Attribute Traceability Matrix, with each row of the table representing the correlation of a specific capability attribute with its USC and MUSC scores, to its KPI and USD for that specific KPI. Capability attribute number, name, USC, MUSC, target score KPI name, KPI goal, or and USD are each stored in a separate column within the table, corresponding to each row for a specific capability attribute. In 320—Business Intelligence, the requirements table created in 310 is augmented with an adjacent column, where the frequency of occurrence for each attribute is counted, recorded and multiplied by the numeric gap between MUSC score and target score. This result is called the weighted attribute value.

The weighted attribute value for each attribute is stored in a second table, called the summary requirements table. Scenarios for improvements needed to attain KPI goals are derived by sequencing the rows of the summary requirements table by priority, with priority being determined based on capability and weighted attribute value. Specific actions are presented in a specific order, which taken together, are indicative of the optimal set actions needed to be taken by the user at a particular point in time to achieve the users KPI goals. The improvement actions needed are displayed from highest priority to lowest priority in a simulation report for user review at the client device. The simulation report (FIG. 5-C—Simulation Report, sample) displays the highest likelihood simulations, defined as the simulation with the highest likelihood to achieve goal, or target value, and illustrates the likelihood of achieving the desired business outcomes (KPI goals), following the implementation of the improvement initiatives suggested in the simulation. Also included are the potential impact—defined as contribution to value goal, and potential effort—defined as the relative cost for each improvement initiative.

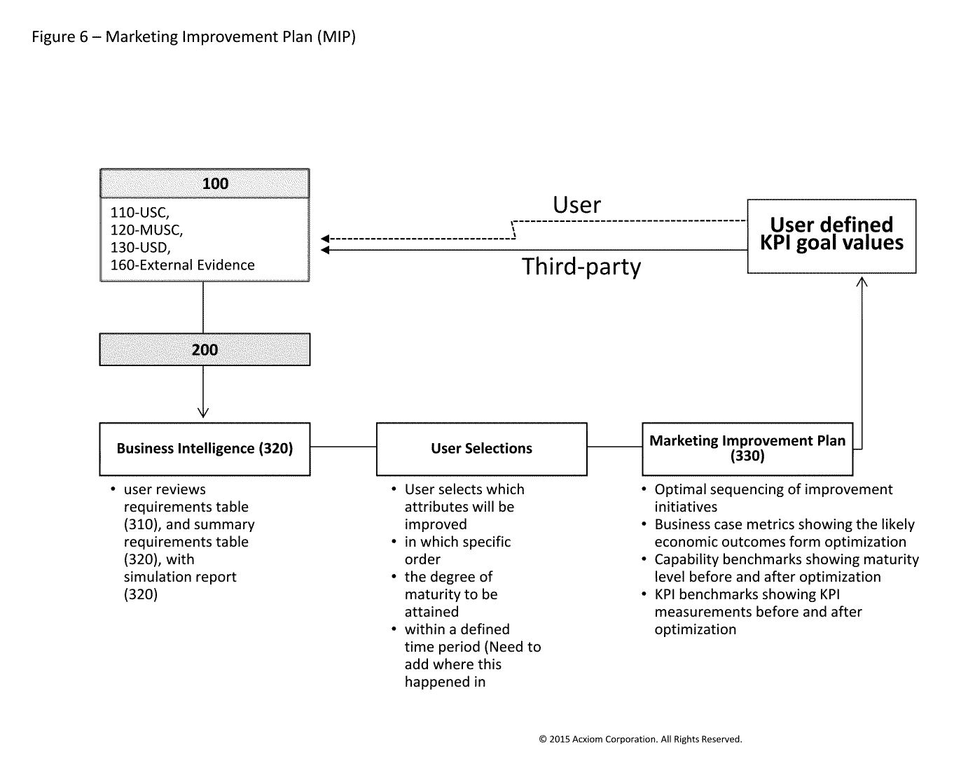

Turning now to FIG. 6—Marketing Improvement Plan, a block diagram is shown illustrating the method by which USC 110, MUSC 120, USD 130, and external evidence 160 are analyzed to develop a unique business improvement plan tailored specifically to the user's inputs and goals. At marketing improvement plan (MIP) 330, a user reviews the requirements table 310, and the summary requirements table 320, along with the simulation report 320 which displays the simulation having the highest likelihood for achieving goal values within the specific time period.

Using the Interactive Game Interface supplied by 100, the user makes selections within the web form, indicating which attributes will be improved, in which specific order, and the degree of maturity to be attained within a defined time period. Once the user makes user selections, the Marketing Improvement Plan (MIP) 330 is published on-screen to the user at the client device, along with the calculated confidence percentage of attaining goal values within the selected time period. The MIP 330 details the specific capability maturity improvements that must be implemented by the user to achieve the users' KPI goals. In addition the MIP illustrates optimal sequencing of improvement initiatives; business case metrics showing the likely economic outcomes form optimization; capability benchmarks showing maturity level before and after optimization; and KPI benchmarks showing KPI measurements before and after optimization. In this way, MIP 330 comes from user decisions regarding specific outputs that are developed by the game and discussed above, which, taken together, address the needs of marketing executives in the modern era, including: (1) attainment of KPI targets, (2) optimization of improvement initiatives, and (3) reductions in computer processing time and resource consumption.

Once the user acts on the initiatives and measures the outcomes, the outcomes are entered into the game through interactive game interface 100, and, following the method described above, new scenarios are developed, leading to increasing levels of optimization, and improved outcomes. After a user executes on the MIP 330, the impact of the actions taken can be expressed in terms of payoffs and other outcomes. These real measures can be recursively added to the particular company's record that becomes part of the normative database. Additional information regarding the difference between actual and predicted performance aids in making further predictions calculated from the NDB 220 more statistically representative. This approach, also known as closed-loop measurement, facilitates the evaluation of progress and is used to make new suggestions for the future, with a high degree of confidence that, once the suggestions are activated, the desired outcomes will be achieved.

Measured outcomes are stored in NDB 220 based on a data model that allows identification of each data element based on user id, session id, company id, department or division within company, and USC, USD, MUSC, and external evidence element id. Based on this data model, USC, USD, MUSC and external evidence from many different game sessions may be stored in the database and used for modeling.

Because this data model and database are hosted off-premise from the user, and maintained in a centralized, secure, internet cloud architecture, the marketing capabilities computer processing and resource consumption from an individual user are dramatically reduced, and total computer processing and resource consumption is optimized across many users and user sessions.

The user may revisit MIP 330 in multiple, subsequent game sessions, to update the USC and USD with current period USC and USD. Following each game session, MIP 330 may be refreshed with new action optimization suggestions. With each new user session, the underlying statistical associations become more statistically representative at a higher level of confidence.

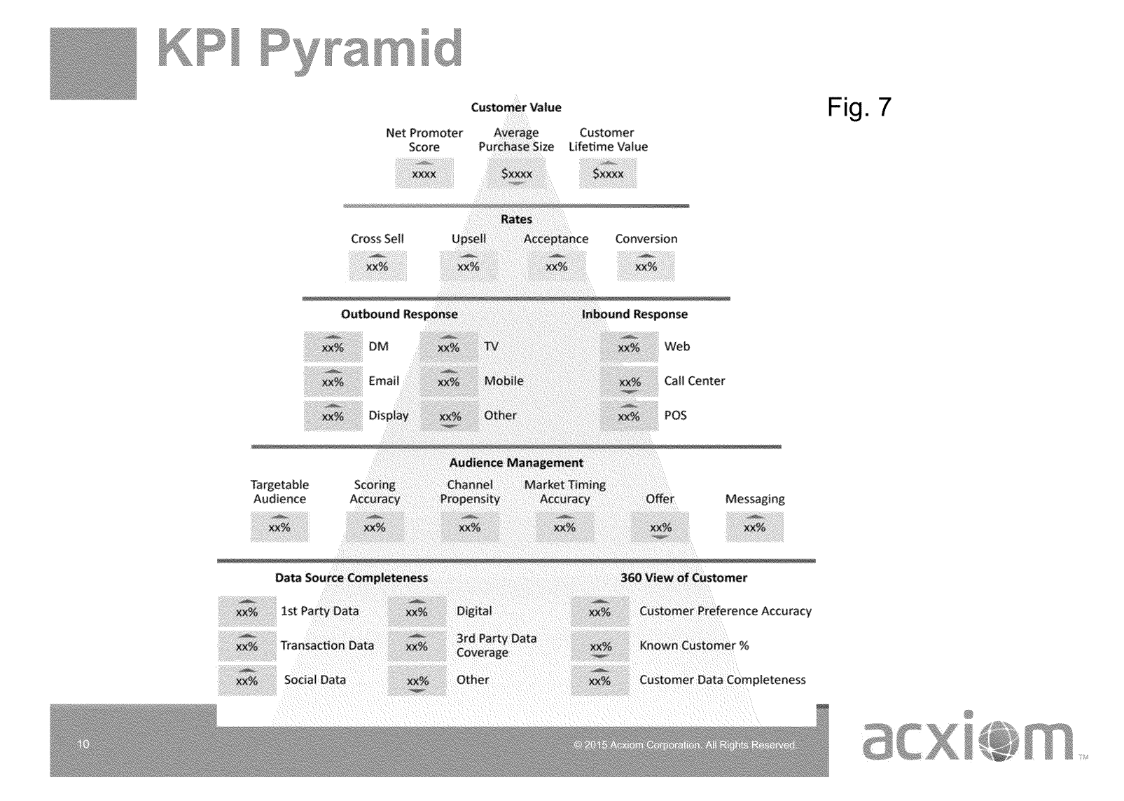

Turning now to FIG. 7, the KPI Pyramid is used to illustrate the body of knowledge (BoK) for marketing performance. The framework enables benchmarking of marketing performance (i.e.; not just marketing capability). Current and target KPIs required for game play are organized into a specific hierarchy for marketing performance known as the KPI pyramid. Current and target Key Performance Indicators (KPIs) are organized into a logical hierarchy, from top to bottom, with customer value organized at the top of the hierarchy. The KPIs that are accretive to customer value are organized logically below, and make up the body of the pyramid. The individual KPIs that are depicted on the screen are an illustration of the entire BoK for marketing KPIs. The BOK contains the full set of KPIs that are available to players of the game. An individual simulation session may include some, or all, of the KPIs, as determined by the simulation player in defining game scenarios.

During simulation, the player enters the current and target KPIs, and KPI measurements (values). These data elements are essential in certain implementations to game play. The KPI Pyramid is used as an element in the methodology, which connects marketing KPIs with marketing maturity capabilities. The simulation leverages all of the elements of this invention described above, as well as the architecture that is illustrated.

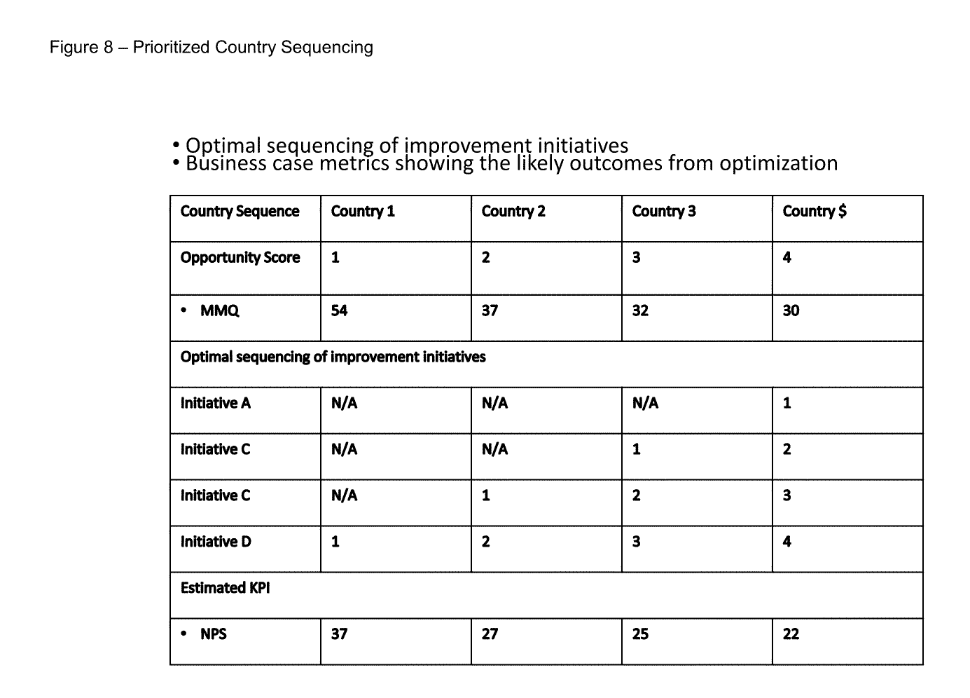

Turning now to FIG. 8—Prioritized Country Sequencing a table diagram is shown illustrating the optimal sequencing of improvement initiatives, and the metrics showing the likely outcomes from optimization. The data correlation module (FIG. 4) has two major components that ultimately produce information that populates other tables, including FIG. 8—Prioritized Country Sequencing: (1) the Body of Knowledge (BOK) represented by the records in the anonymized normalized database NDB 220, and (2) all of the information supplied by a user or authorized third party acting on behalf of a company or company division. Combining these two components is what allows the game to assimilate information from a user and generate predictions regarding various outcomes and payoffs

The present invention has been described with reference to the foregoing specific implementations. These implementations are intended to be exemplary only, and not limiting to the full scope of the present invention. Many variations and modifications are possible in view of the above teachings. The invention is limited only as set forth in the appended claims. All references cited herein are hereby incorporated by reference to the extent not inconsistent with the disclosure herein. Unless explicitly stated otherwise, flows depicted herein do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims. Any disclosure of a range is intended to include a disclosure of all ranges within that range and all individual values within that range.

1. A method for collecting, assembling, modifying and evaluating content and data about an organization for performing marketing scenario simulation, predicting specific, measurable outcomes that are empirically reproducible, and making, testing, and optimizing specific business decisions surrounding capability improvement programs for marketing to consumers at a remote computing device comprising a processor, comprising the steps of:
a. sending to a user device comprising a web browser a user interface generated by the remote processor;
b. receiving through the user interface a set of user supplied content (USC) pertaining to the current maturity level of a plurality of marketing maturity attributes for the organization;
c. receiving through the user interface a set of user supplied data (USD) pertaining to a set of KPIs for the organization;
d. receiving through the user interface a set of defined output relating to the business rules and instructions pertaining to the organization;
e. receiving external evidence related to the organization;
f. modifying the USC by means of the extrinsic evidence to produce modified user supplied content (MUSC);
g. correlating USC, MUSC, and USD with a normative database (NDB) to produce normalized data, thereby obtaining specific marketing performance predictions for the organization, based on the USC, MUSC, and USD, and used in conjunction with predictive relationships among variables in the NDB;
h. identifying predictive relationships based on correlations among variables in the NDB;
i. receiving at the processor from the user interface a targeted desired state;
j. generating a report indicating current maturity for each set of business challenges, or a subset thereof, and the desired targeted state; and
k. outputting to the user interface a marketing improvement plan (MIP).

2. The method of claim 1, wherein the extrinsic evidence is gathered by a party other than the user and a party performing the simulation.

3. The method of claim 1, wherein the correlative relationships established with the NDB are combined with user supplied information to yield predictive models for estimating outcomes and payoffs for the organization.

4. The method of claim 1, wherein the comparisons of the organization to all, or a subset, of the NDB is established with univariate statistics.

5. The method of claim 1, wherein the MIP is based on business intelligence.

6. The method of claim 1, wherein the correlation with the NDB is created by establishing in a requirements table a relationship of attributes to KPIs and an associated USD for each KPI.

7. The method of claim 6, wherein the requirements table comprises an attribute frequency of occurrence with the gaps between MUSC and a target score for each MUSC, resulting in a weighted attribute value.

8. The method of claim 7, wherein the weighted attribute value for each attribute is stored in a summary requirements table.

9. The method of claim 8, further comprising the step of sequencing rows of the requirements table by priority, based on capability and weighted attribute value, to result in at least one scenario for improving at least one KPI to reach stated goals of the organization.

10. The method of claim 9, further comprising the creation of a simulation report and delivery of the simulation report to the user interface, wherein the simulation report comprising a listing of specific actions in a specific order that will indicate the optimal set of actions needed according to the simulation comprising at least one scenario to achieve stated KPI goals.

11. The method of claim 10, wherein improvement actions for KPIs are sorted in rank order by probability of obtaining desired business outcome.

12. The method of claim 7, further comprising the step of delivering to the user interface the requirements table.

13. The method of claim 12, further comprising the step of delivering to the user a summary of the requirements table.

14. The method of claim 1, wherein a set of attributes to be improved, level of improvement, time frame of improvement, and ordering of improvement are received through the user interface at the processor prior to generation of the MIP.

15. The method of claim 14, wherein the MIP comprises a calculated confidence percentage of attaining goals over the time frame of improvement.

16. The method of claim 15, wherein the MIP comprises an optimal sequencing of improvement initiatives, business case metrics showing potential economic outcomes from optimization and KPI benchmarks before and after optimization.

17. The method of claim 1, further comprising the step, after the MIP has been sent to the user interface, of receiving through the user interface a second set of user supplied data (USD) pertaining to the KPIs for the organization.

18. The method of claim 18, further comprising the steps of:
a. recursively re-correlating USC, MUSC, and USD with the NDB;
b. identifying additional predictive relationships based on the correlation performed with the NDB; and
c. outputting to the user interface an updated marketing improvement plan (MIP).

19. The method of claim 18, further comprising the step of updating the NDB with the additional predictive relationships and actual measured payoffs and outcomes.

20. The method of claim 1, wherein MIP is based on using mass media to promote above-the-line (ATL) techniques, below-the-line (BTL) techniques, and the underlying operational capabilities necessary to optimize marketing.
